(19) United States
(12) Patent Application Publication
(10) Pub. No.: US 2009/0196660 A1
(43) Pub. Date: Aug. 6, 2009

(54) DEVELOPING APPARATUS CAPABLE OF CONVEYING DEVELOPER UNIFORMLY AND DEVELOPER CONVEYER THEREOF

(76) Inventor: Chin-Lung Han, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/025,063

(22) Filed: Feb. 4, 2008

(51) Int. Cl. G03G 15/08

(52) U.S. Cl. 399/281

(57) ABSTRACT

A developer conveyer for conveying developer includes a shaft, and a plate structure connected to the shaft. Flexural rigidity of a central part of the plate structure is less than flexural rigidity of a lateral part of the plate structure. Deformation of the central part of the plate structure is greater than deformation of the lateral part of the plate structure so that developer moves from the lateral part to the central part of the plate structure when the shaft drives the plate structure to rotate for conveying the developer.

### BACKGROUND OF THE INVENTION

1. Field of the Invention

The present invention relates to a developing apparatus and a developer conveyer thereof, and more particularly, to a developing apparatus capable of conveying developer uniformly and a developer conveyer thereof.

2. Description of the Prior Art

Electrophotographic systems are generally employed in image-forming devices, the operation of which involves several steps: charging, exposing, developing, transferring, fusing, cleaning, and erasing. The color photoelectric image forming devices utilize toners of different colors to form color images. For example, a four-color photoelectric image-forming device utilizes a yellow toner cartridge, a magenta toner cartridge, a cyan toner cartridge, and a black toner cartridge to form color images.

Please refer to FIG. 1. FIG. 1 is a diagram of an image-forming device 10 in the prior art. The image-forming device 10 can be a laser printer, a multi-functional product, and so on. The image-forming device 10 includes a housing 12 for covering inner components of the image-forming device 10, a photoconductive belt 14, a charger 16, an exposing device 18, a developing device 20 including a plurality of developing apparatus, a clean device 22, a transfer roller 24, a fuser 26, and a discharge unit 28. When the image-forming device 10 prints an image, as the first step of the entire process, the charger 16 charges a surface of the photoconductive belt 14 to a charged potential. The exposing device 18 exposes the photoconductive belt 14 to form a latent image on the photoconductive belt 14. The toners stored in the plurality of developing apparatus are jumped onto the latent image to form a toner image. The transfer roller 24 transfers the toner image on a print medium 30, such as paper. At last, the fuser 26 fuses the toners on the print medium 30. The clean device 22 cleans the rest toners on the photoconductive belt 14, and the discharge unit 28 discharges the rest charged potential on the photoconductive belt 14.

The toners stored in the developing apparatus are provided for the laser printing device to print an image. The flow of the toners inside the developing apparatus influence print quality of the laser printing device and utilization efficiency of the toners. That is, the unsatisfactory design of flow of the toners causes low image print quality and inefficient utilization of the toners.

### SUMMARY OF THE INVENTION

It is therefore a primary objective of the invention to provide a developing apparatus capable of conveying developer uniformly and a developer conveyer thereof for solving the above-mentioned problem.

According to the claimed invention, a developer conveyer for conveying developer includes a shaft, and a plate structure connected to the shaft. Flexural rigidity of a central part of the plate structure is less than flexural rigidity of a lateral part of the plate structure. Deformation of the central part of the plate structure is greater than deformation of the lateral part of the plate structure so that developer moves from the lateral part to the central part of the plate structure when the shaft drives the plate structure to rotate for conveying the developer.

According to the claimed invention, a developing apparatus includes a housing. An opening is formed on the housing, and a containing chamber is formed inside the housing for containing developer. A first protrusion and a second protrusion are formed on an inner side of the housing, and there is a height difference between the first protrusion and the second protrusion. The developing apparatus further includes a developer carrying member installed near the opening of the housing and protruding from the opening partly, a rotatable supply member installed inside the housing and contacting with the developer carrying member for supplying the developer to the developer carrying member, and a developer conveyer installed inside the containing chamber for conveying the developer to the supply member.

According to the claimed invention, a developing apparatus includes a housing having a first chamber and a second chamber. A rotatable developer carrying member is disposed in the first chamber and a rotatable supply member is disposed in the first chamber and cooperative with the developer carrying member to form a nip therebetween for supplying the developer to the developer carrying member. A developer conveyer is installed inside the second chamber for conveying the developer to the supply member. The developer conveyer includes a plate structure, wherein the flexural rigidity of the plate structure increases from a central part to a lateral part gradually.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a laser printing device in the prior art.

FIG. 2 is a schematic drawing of a developing apparatus according to a preferred embodiment of the present invention.

FIG. 3 is a lateral sectional diagram of the developing apparatus according to the preferred embodiment of the present invention.

FIG. 4 and FIG. 5 are schematic drawings of a first developer conveyer according to preferred embodiments of the present invention.

FIG. 6 is a force diagram of a plate structure and developer of the present invention.

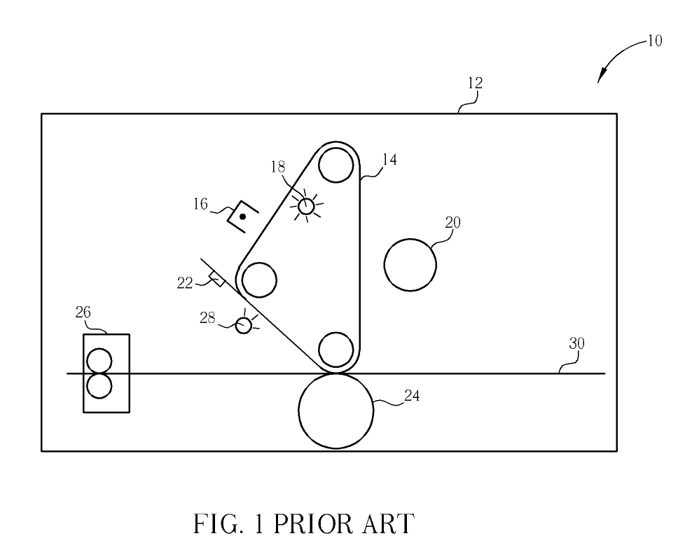

### DETAILED DESCRIPTION

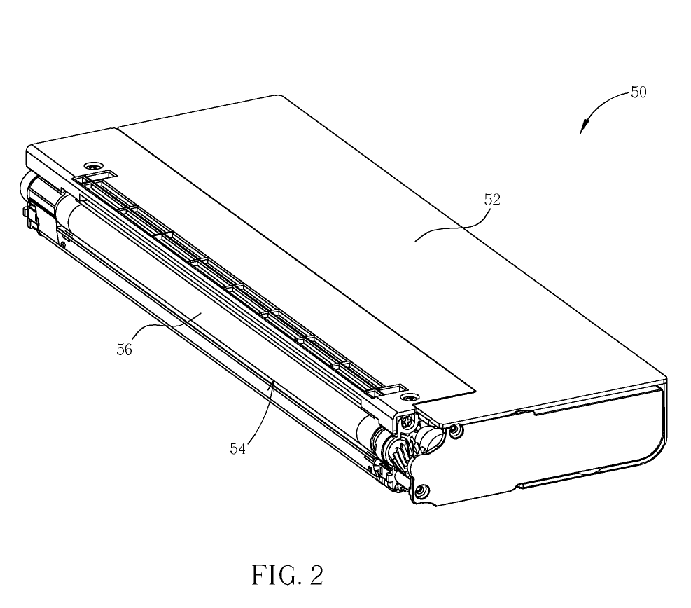

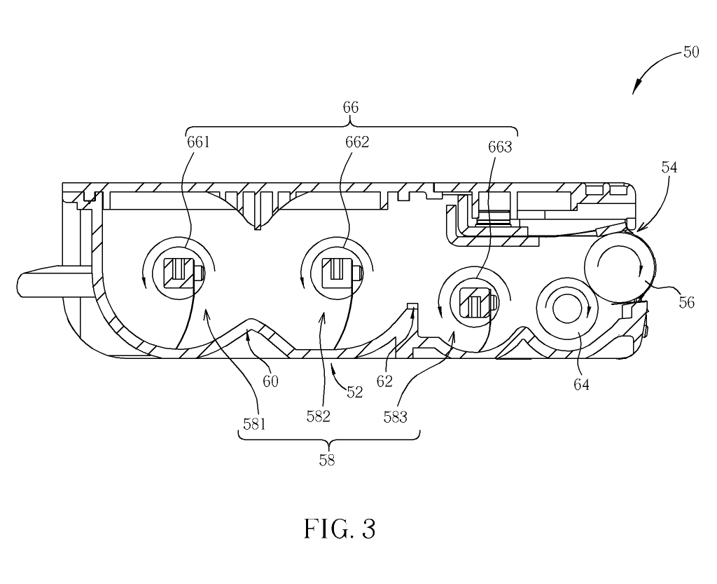

Please refer to FIG. 2 and FIG. 3. FIG. 2 is a schematic drawing of a developing apparatus 50 according to a preferred embodiment of the present invention. FIG. 3 is a lateral sectional diagram of the developing apparatus 50 according to the preferred embodiment of the present invention. The developing apparatus 50, which can be a flat toner cartridge, can be installed inside a casing of a laser printing device. The developing apparatus 50 includes a housing 52 having a first chamber (including a first developer container 581 and second developer container 582) and a second chamber (including a third developer container 583) for covering inner components and containing developer, such as toners. An opening 54 is formed on the housing 52. The developing apparatus 50 further includes a rotatable developer carrying member 56, which can be a developer roller, installed inside the first chamber and near the opening 54 of the housing 52 and protruding from the opening 54 partly for developing the developer inside the housing 52 to a photoconductive component, such as a photoconductive drum or a photoconductive belt. The developer carrying member 56 can be composed of a roller mechanism, such as a metal tubular mechanism or a tubular mechanism made of elastic material. A surface of the developer carrying member 56 can be a coating surface or be processed by a sand blasting method. A containing chamber 58 is formed inside the housing 52 for containing developer. A first protrusion 60 and a second protrusion 62 are formed on an inner and bottom side of the housing 52, and there is a height difference between the first protrusion 60 and the second protrusion 62. The first protrusion 60 and the second protrusion 62 divide the containing chamber 58 into the first developer container 581, the second developer container 582, and the third developer container 583. The developing apparatus 50 further includes a rotatable supply member 64, which can be a supply roller, installed inside the first chamber of housing 52 and contacting with the developer carrying member 56, and cooperative with the developer carrying member 56 to form a nip therebetween for supplying the developer to the developer carrying member 56. The supply member 64 can be composed of a roller mechanism made of foaming material. The developing apparatus 50 further includes a developer conveyer mechanism 66 installed inside the containing chamber 58 for conveying the developer. The developer conveyer mechanism 66 can be a toner paddle mechanism. At least one developer conveyer, such as a toner paddle, is disposed inside each developer container preferredly. For example, the developer conveyer mechanism 66 includes a first developer conveyer 661 installed inside the first developer container 581, a second developer conveyer 662 installed inside the second developer container 582, and a third developer conveyer 663 installed inside the third developer container 583. As shown in FIG. 3, the first developer conveyer 661, the second developer conveyer 662, and the third developer conveyer 663 of the developer conveyer mechanism 66 rotate in a counterclockwise direction shown as arrows. The first developer conveyer 661 conveys the developer from the first developer container 581 to the second developer container 582. The second developer conveyer 662 conveys the developer from the second developer container 582 to the third developer container 583. The third developer conveyer 663 conveys the developer from the third developer container 583 to the supply member 64. Then the supply member 64 conveys the developer to the developer carrying member 56. The mechanical design of the developer conveyer mechanism 66 conveying the developer between different developer containers and then to the supply member 64 makes the shape of the developing apparatus 50 flat so as to reduce height of the developing apparatus 50 and to save inner space of the laser printing device. Because the developer is conveyed from the developer conveyer mechanism 66 to the supply member 64 continuously, the developer might heap nearby the supply member 64 causing inefficient transportation of developer. For solving this problem, the first protrusion 60 and the second protrusion 62 are formed on the inner and bottom side of the housing 52, and there is the height difference between the first protrusion 60 and the second protrusion 62 so that there are height differences between the first developer container 581, the second developer container 582, and the third developer container 583 for assisting the developer in backflow to the developer container distant from the supply member 64 effectively. It can make the developer stirred uniformly so that the developer can not block up on a certain section of the containing chamber 58. For example, when the developer stored in the second developer container 582 are higher than the first protrusion 60, the developer stored in the second developer container 582 flow back to the first developer container 581 for preventing the developer from heaping in the second developer container 582 excessively. Similarly, when the developer stored in the third developer container 583 are higher than the second protrusion 62, the developer stored in the third developer container 583 flow back to the second developer container 582 for preventing the developer from heaping in the third developer container 583 excessively. It can avoid triangular banks of the developer because there are height differences between the developer containers.

In addition, a plurality of protrusions with height differences can be formed on the inner and bottom side of the housing 52 of the present invention without limitation of two protrusions in the above-mentioned embodiment so as to divide the containing chamber 58 into corresponding developer containers.

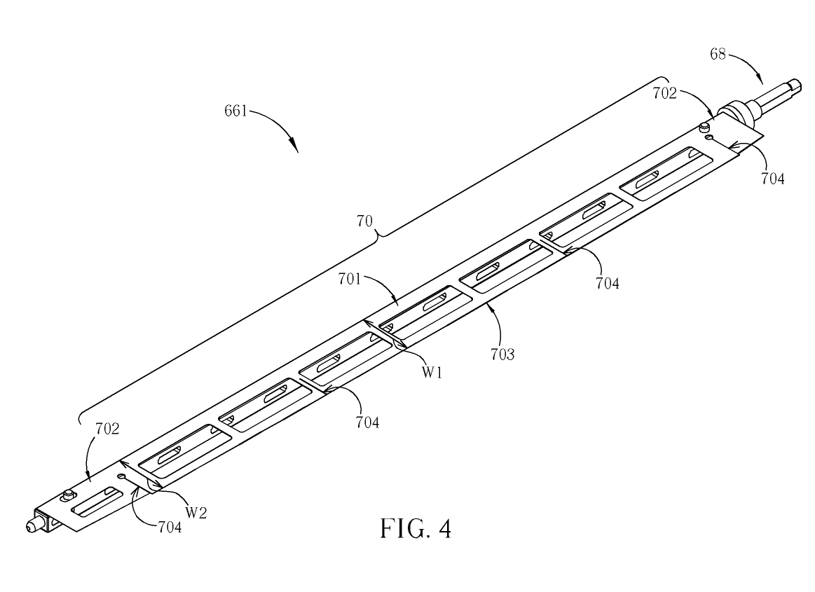

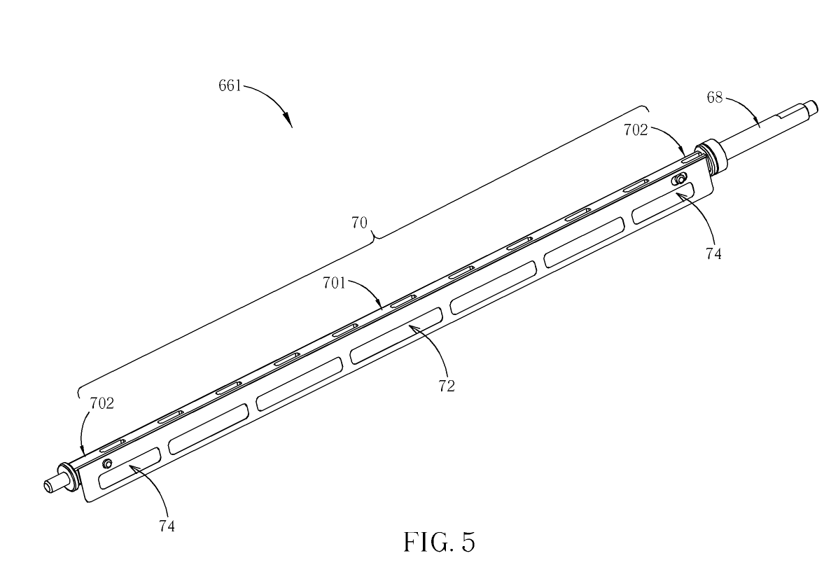

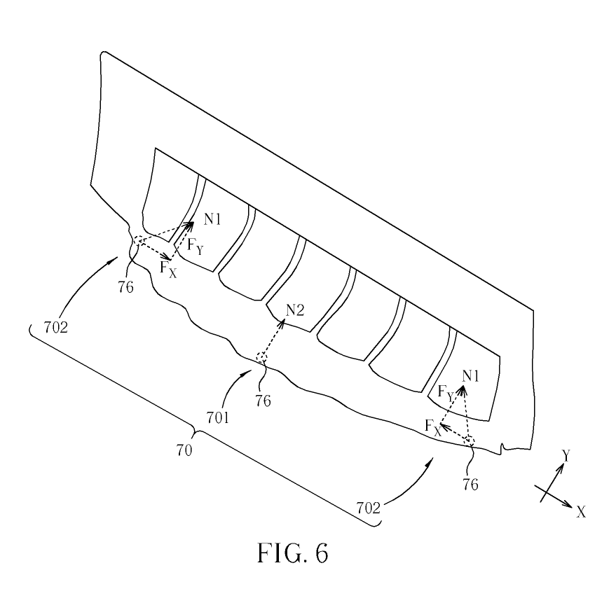

Please refer to FIG. 4 and FIG. 5. FIG. 4 and FIG. 5 are schematic drawings of the first developer conveyer 661 according to preferred embodiments of the present invention. As shown in FIG. 4 and FIG. 5, the first developer conveyer 661 includes a shaft 68 and a plate structure 70 connected to the shaft 68. The shaft 68 is connected to a driving device (not shown in figures) so as to be driven to rotate the plate structure 70 to stir and convey the developer. The plate structure can be made of Mylar material. Flexural rigidity of a central part 701 of the plate structure 70 is less than flexural rigidity of two lateral parts 702 of the plate structure 70. That is, the flexural rigidity of the plate structure 70 increases from the central part 701 to the lateral parts 702 gradually. For example, as shown in FIG. 4, a width W1 of the central part 701 of the plate structure 70 is greater than a width W2 of the lateral part 702 of the plate structure 70 so that the flexural rigidity of the central part 701 of the plate structure 70 is less than the flexural rigidity of the lateral parts 702 of the plate structure 70. A bottom surface 703 of the plate structure 70 is of an arc shape. A plurality of notches 704 can be disposed on the plate structure 70 nonequidistantly for sectioning the plate structure 70 unequally so that the flexural rigidity of the central part 701 of the plate structure 70 is less than the flexural rigidity of the lateral parts 702 of the plate structure 70. That is, the plate structure 70 is composed of sub plate structures of different sizes. Please refer to FIG. 5. A plurality of openings is disposed on the plate structure 70. A first opening 72 is disposed on the central part 701, and second openings 74 are disposed on the lateral parts 702 respectively. An area of the first opening 72 is greater than an area of the second opening 74. A plurality of openings can be disposed between the first opening 72 and the second openings 74 selectively, and an area of an opening close to the central part 701 is greater than an area of an opening close to the lateral part 702 so that the flexural rigidity of the central part 701 of the plate structure 70 is less than the flexural rigidity of the lateral parts 702 of the plate structure 70. In conclusion, because the flexural rigidity of the central part 701 of the plate structure 70 is less than the flexural rigidity of the lateral parts 702 of the plate structure 70, deformation of the central part 701 of the plate structure 70 is greater than deformation of the lateral part 702 of the plate structure 70 when the shaft 68 drives the plate structure 70 to rotate for conveying the developer. All structural designs for achieving that the flexural rigidity of the central part 701 of the plate structure 70 is less than the flexural rigidity of the lateral parts 702 of the plate structure 70 are within the scope of the present invention. Please refer to FIG. 6. FIG. 6 is a force diagram of the plate structure 70 and the developer of the present invention. When the plate structure 70 moves developer 76 in the arrow direction, the lateral parts 702 of the plate structure 70 apply normal forces N1 to the developer 76 respectively and the central part 701 of the plate structure 70 apply a normal forces N2 to the toner 76. The normal force N1 can be decomposed into a component force F_{X} in X direction and a component force F_{Y} in Y direction. The component force F_{Y} in Y direction can move the toner 76 in the Y direction so that the developer can be conveyed between different developer containers. The component force F_{X} in X direction can move the toner 76 from the lateral part 702 to the central part 701 in the X direction so as to gather the developer to the central part 701 of the plate structure 70. It makes the utilization of the developer efficient because the demand for developer on a central part of a print image is always greater than the demand for developer on a margin of the print image. Similarly, the structural designs of the second developer conveyer 662 and the third developer conveyer 663 can be the same as the structural design of the first developer conveyer 661, and thus a further description is hereby omitted.

In conclusion, the protrusions with height differences are disposed on the inner and bottom side of the housing of the developing apparatus of the present invention so that there are height differences between developer containers. It can make the developer flow back to the developer container distant from the supply member so that the developer can not block up on a certain section of the containing chamber and can be stirred uniformly. Furthermore, because the flexural rigidity of the central part of the plate structure of the developer conveyer is less than the flexural rigidity of the lateral parts of the plate structure of the developer conveyer, the developer can be conveyed from the lateral parts to the central part of the plate structure so as to gather the developer on a central part of the developing apparatus for efficient toner utilization. The developing apparatus and the developer conveyer thereof of the present invention can increase flow efficiency and utilization of the developer.

In contrast to the prior art, the developing apparatus and the developer conveyer thereof of the present invention can solve the problem of block developer in the developer container and gather the developer on a central part of the developing apparatus for efficient developer utilization. The present invention can increase print quality and print efficiency of the laser printing device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A developer conveyer for conveying developer comprising:
a shaft, and
a plate structure connected to the shaft, flexural rigidity of a central part of the plate structure being less than flexural rigidity of a lateral part of the plate structure, and deformation of the central part of the plate structure being greater than deformation of the lateral part of the plate structure so that developer moves from the lateral part to the central part of the plate structure when the shaft drives the plate structure to rotate for conveying the developer.

2. The developer conveyer of claim 1 wherein a width of the plate structure decreases from the central part to the lateral part gradually.

3. The developer conveyer of claim 1 wherein a bottom surface of the plate structure is of an arc shape.

4. The developer conveyer of claim 1 wherein a plurality of notches is disposed on the plate structure for sectioning the plate structure.

5. The developer conveyer of claim 1 wherein the plurality of notches is disposed on the plate structure nonequidistantly.

6. The developer conveyer of claim 1 wherein a plurality of openings is disposed on the plate structure and an area of an opening close to the central part is greater than an area of an opening close to the lateral part.

7. The developer conveyer of claim 1 wherein the flexural rigidity of the plate structure increases from the central part to the lateral part gradually.

8. The developer conveyer of claim 1 wherein the plate structure is made of Mylar material.

9. A developing apparatus comprising:
a housing, an opening being formed on the housing and a containing chamber being formed inside the housing for containing developer, a first protrusion and a second protrusion being formed on an inner side of the housing, and a height difference being between the first protrusion and the second protrusion;
a developer carrying member installed near the opening of the housing and protruding from the opening partly;
a supply member installed inside the housing and contacting with the developer carrying member for supplying developer to the developer carrying member; and
a developer conveyer mechanism installed inside the containing chamber for conveying the developer to the supply member.

10. The developing apparatus of claim 9 wherein the first protrusion and the second protrusion divide the containing chamber into a first developer container, a second developer container, and a third developer container.

11. The developing apparatus of claim 10 wherein the developer conveyer mechanism comprises:
a first developer conveyer installed inside the first developer container;
a second developer conveyer installed inside the second developer container; and
a third developer conveyer installed inside the third developer container.

12. The developing apparatus of claim 9 wherein the developer conveyer mechanism comprises at least one developer conveyer, the developer conveyer comprising:
a shaft, and
a plate structure connected to the shaft, flexural rigidity of a central part of the plate structure being less than flexural rigidity of a lateral part of the plate structure, and deformation of the central part of the plate structure being greater than deformation of the lateral part of the plate structure so that the developer moves from the lateral part to the central part of the plate structure when the shaft drives the plate structure to rotate for conveying the developer.

13. The developing apparatus of claim 12 wherein a width of the central part of the plate structure is greater than a width of the lateral part of the plate structure.

14. The developing apparatus of claim 12 wherein a bottom surface of the plate structure is of an arc shape.

15. The developing apparatus of claim 12 wherein a plurality of notches is disposed on the plate structure for sectioning the plate structure.

16. The developing apparatus of claim 15 wherein the plurality of notches is disposed on the plate structure nonequidistantly.

17. The developing apparatus of claim 12 wherein a plurality of openings is disposed on the plate structure and an area of an opening close to the central part is greater than an area of an opening close to the lateral part.

18. The developing apparatus of claim 12 wherein the flexural rigidity of the plate structure increases from the central part to the lateral part gradually.

19. A developing apparatus comprising:
a housing, comprising a first chamber and a second chamber;
a developer carrying member disposed in the first chamber;
a supply member disposed in the first chamber and cooperative with the developer carrying member to form a nip therebetween for supplying developer to the developer carrying member; and
a developer conveyer installed inside the second chamber for conveying the developer to the supply member, the developer conveyer comprising:
a plate structure wherein flexural rigidity of the plate structure increases from a central part to a lateral part gradually.

20. The developing apparatus of claim 19 wherein a plurality of protrusions is formed on an inner side of the housing and height differences are between the plurality of protrusions.
